(19) United States
(12) Patent Application Publication
(10) Pub. No.: US 2021/0012204 A1
(43) Pub. Date: Jan. 14, 2021

(54) DIAGNOSTIC METHOD, LEARNING METHOD, LEARNING DEVICE, AND STORAGE MEDIUM STORING PROGRAM

(71) Applicant: DENSO CORPORATION, Kariya-city (JP)

(72) Inventor: Hiroshi KUWAJIMA, Kariya-city (JP)

(21) Appl. No.: 16/920,807

(22) Filed: Jul. 6, 2020

(30) Foreign Application Priority Data
Jul. 8, 2019 (JP) 2019-127103

(51) Int. Cl. G06N 3/08; G06N 5/04; G06F 17/16

(52) U.S. Cl. CPC G06N 3/084; G06F 17/16; G06N 5/046

(57) ABSTRACT

In a method or a device for learning of a neural network, a mathematical expression is calculated, represents an output with respect to an input in each layer of a neural network, and is expressed by F(X)=K(W^{T}X) when the output is defined as F, the input is defined as X, nonlinear conversion is defined as K, and a parameter matrix is defined as W. Multiple eigenvalues of a matrix obtained by inputting the parameter matrix to the input of the mathematical expression and squaring the matrix are calculated as multiple square eigenvalues.

### CROSS REFERENCE TO RELATED APPLICATION

The present application claims the benefit of priority from Japanese Patent Application No. 2019-127103 filed on Jul. 8, 2019. The entire disclosure of the above application is incorporated herein by reference.

### TECHNICAL FIELD

The present disclosure relates to a technique for performing neural network learning.

### BACKGROUND ART

A neural network is a type of machine learning. In the machine learning, sample data derived from a sensor, a database, or the like is input and analyzed, and a useful rule, a rule, a knowledge expression, determination criteria, or the like are extracted from the data to develop an algorithm. The neural network learning often provides correct answer data (supervised learning) and gradually learns the parameters of a neural network (error back propagation method) so as to minimize errors to the correct answer data.

### SUMMARY

In a method or a device for learning of a neural network, a mathematical expression may be calculated, represent an output with respect to an input in each layer of a neural network, and be expressed by F(X)=K(W^{T}X) when the output may be defined as F, the input may be defined as X, K may be defined as nonlinear conversion, and W may be defined as a parameter matrix. Multiple eigenvalues of a matrix obtained by inputting the parameter matrix to the input of the mathematicalexpression and squaring the matrix may be calculated as multiple square eigenvalues.

### BRIEF DESCRIPTION OF DRAWINGS

The above and other features and advantages of the present disclosure will become more apparent from the following detailed description made with reference to the accompanying drawings. In the drawings,

FIG. 1A is a diagram showing an example of a multilayer neural network.

FIG. 1B is a diagram showing the neural network of FIG. 1A from which a first layer is extracted.

FIG. 2 is a flowchart showing a diagnostic method according to the embodiment.

FIG. 3 is a diagram showing a configuration of a learning device according to the embodiment.

FIG. 4 is a graph illustrating a logarithmic barrier.

FIG. 5A is a diagram illustrating a low-rank approximation.

FIG. 5B is a diagram illustrating the low-rank approximation.

FIG. 6 is a flowchart showing a learning method according to the embodiment.

### DETAILED DESCRIPTION

When performing supervised learning by the error back propagation method, especially when learning a deep neural network (deep learning), an error(gradient) may vanish (gradient vanishment) or an error (gradient) may become excessively large (gradient explosion) in a process of propagating a hierarchy in which the error to be minimized is deep. If the gradient vanishment or the gradient explosion occurs, learning of the neural network may not be successful.

One example of the present disclosure provides a technique for diagnosing a gradient vanishment or a gradient explosion in a neural network learning. Another object of the present disclosure provides a technique for preventing the gradient vanishment or the gradient explosion from occurring during learning.

According to one example embodiment, a diagnostic method includes; calculating a mathematical expression that represents an output for an input in each layer of a neural network and is expressed by the following mathematical expression (1) when the output is defined as F, the input is defined as X, nonlinear conversion is defined as K, and a parameter matrix is defined as W, in learning of the neural network; calculating multiple eigenvalues of a matrix obtained by inputting the parameter matrix to the input of the mathematical expression and squaring the matrix as multiple square eigenvalues; and determining a gradient vanishment or a gradient explosion based on a distribution of the multiple square eigenvalues.

F(X)=K(W^{T}X) [Mathematical expression (1)]

The present inventor has found that an eigenvalue of a conversion matrix of each layer can be used to determine whether a state causes a gradient vanishment or a gradient explosion. In the present disclosure, the determination is not performed based on the gradient itself. Alternatively, the conversion matrix is used to determine whether the parameter of the neural network is in a state that causes the gradient vanishment or the gradient explosion. Here, since the conversion matrix is a matrix obtained by inputting a parameter matrix W to an input X, the conversion matrix is expressed by the following mathematical expression (2).

Σ_{K,W}=F(W)=K(W^{T}W) [Mathematical expression (2)]

Since a nonlinear conversion K is applied to the conversion matrix, a sign of the eigenvalue is unknown, and therefore, in the present disclosure, an eigenvalue (called the square eigenvalue) for a matrix obtained by squaring the conversion matrix is defined, and the gradient vanishment and the gradient explosion are diagnosed based on a distribution of the square eigenvalue.

According to another example embodiment, a learning method learns a neural network model and includes repeatedly: calculating a mathematical expression that represents an output for an input in each layer of a neural network and is expressed by the following mathematical expression (3) when the output is defined as F, the input is defined as X, nonlinear conversion is defined as K, and a parameter matrix is defined as W; calculating multiple eigenvalues of a matrix obtained by inputting the parameter matrix to the input of the mathematical expression and squaring the matrix as multiple square eigenvalues; and learning the neural network model by utilizing a loss function including a penalty for controlling the multiple square eigenvalues.

F(X)=K(W^{T}X) [Mathematical expression (3)]

With the inclusion of a penalty for controlling the square eigenvalue in a loss function in this manner, the square eigenvalue can be controlled to implement learning with reduced occurrence of the gradient vanishment or gradient explosion.

According to the present disclosure, learning with reduced occurrence of the gradient vanishment or gradient explosion can be implemented.

Hereinafter, a diagnostic method and a learning method according to an embodiment of the present disclosure will be described. In the following description, a method for diagnosing the occurrence of a gradient vanishment and a learning method in which the occurrence of the gradient vanishment is reduced will be described.

(Neural Network)

A neural network has one or more layers between an input layer and an output layer, and has a structure in which an output from each layer is input to a next layer.

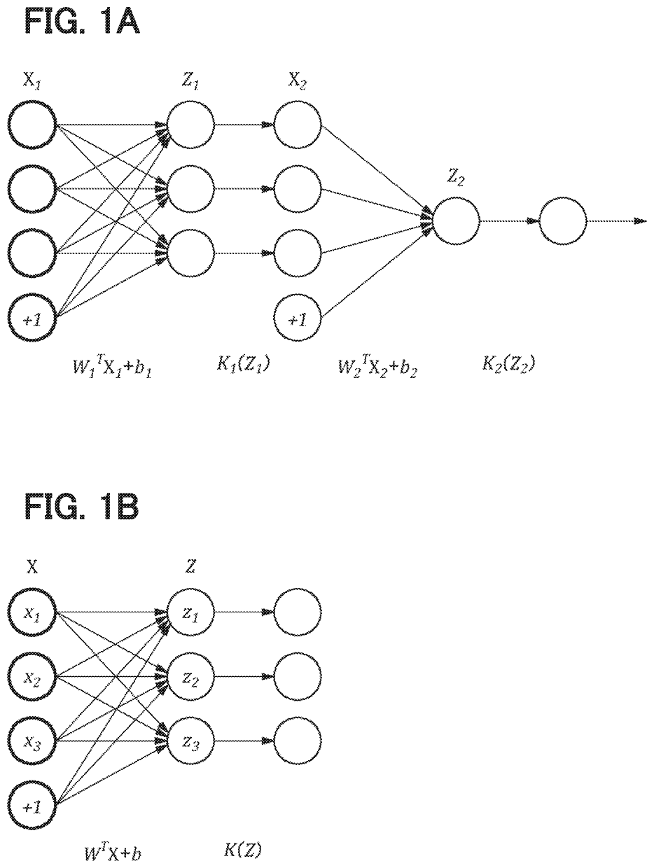

FIG. 1A shows an example of a multilayer neural network, and FIG. 1B shows the neural network of FIG. 1A from which one layer is extracted. Values output from a leftmost node group X1 (including nodes x1 to x3) and a node outputting “1” in FIG. 1B are multiplied by a weight and input to a middle node group Z1 (including nodes z1 to z3). The conversion at the nodes multiplied by the weight is expressed by a linear conversion of WTX +b. Incidentally, uppercase letters represent matrices, and lowercase letters represent elements (scalar values) of matrices.

A middle node group Z1 outputs a value corresponding to the input value. In those nodes, a value corresponding to the input value is output by nonlinear conversion utilizing a sigmoid function, a ReLU function, or the like. The nonlinear conversion is expressed by K(X). The function used in this case is not limited to the sigmoid function and the ReLU function, and various functions such as a truncated power function and a step function can be used.

Therefore, the input/output conversion performed in each layer of the neural network can be expressed by the following mathematical expression (4).

F(X)=K(W^{T}X) [Mathematical expression (4)]

(Diagnostic Methods)

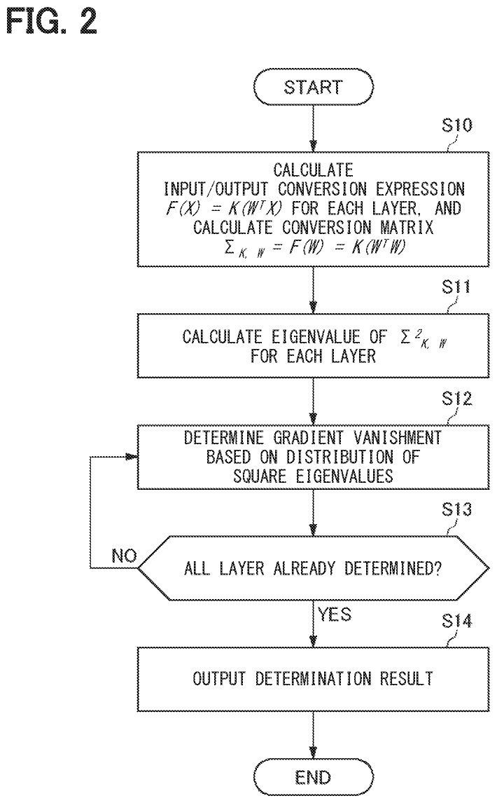

FIG. 2 is a flowchart showing a diagnostic method according to the present embodiment.

In the diagnostic method according to the embodiment, first, a conversion expression (the above mathematical expression (1)) of input and output in each layer of the neural network model being learned is obtained, and a conversion matrix (the above expression (2) is obtained from the conversion expression (S10). Next, an eigenvalue of the matrix obtained by inputting a parameter matrix W to the input X of the conversion expression and squaring the resulting matrix is obtained as a square eigenvalue (S11), and it is determined whether a gradient vanishment occurs based on the distribution of the square eigenvalue (S12). Although the multiple square eigenvalues exist in the conversion matrix of each layer, when the square eigenvalues are widely distributed from a large value to a small value, the parameters of the corresponding layer are not degenerated and the gradient vanishment is unlikely to occur. Conversely, when the values of all the square eigenvalues become too small and the parameters are degenerated, the gradient vanishment is likely to occur.

In the present embodiment, the following criterion is used in order to determine the distribution of the square eigenvalue.

(1) Ratio of Square Eigenvalues

As the ratio of the square eigenvalues, for example, a ratio of the maximum square eigenvalue and the minimum square eigenvalue may be taken, and whether the ratio is larger than a predetermined threshold may be determined, and when the ratio is larger than the predetermined threshold, it may be determined that the square eigenvalues are widely distributed.

(2) Absolute Value of Square Eigenvalue

As an absolute value of the square eigenvalue, an absolute value of the maximum square eigenvalue may be used. When the maximum square eigenvalue is larger than a predetermined threshold, it is determined that the square eigenvalues are widely distributed. The least square eigenvalue may also be used to determine whether the least square eigenvalue is very close to zero. When the square eigenvalue is very close to 0, a column vector of the linear conversion is not linearly independent, so that the gradient vanishment occurs. Whether the square eigenvalue is very close to 0 can be determined by whether a difference between the square eigenvalue and 0 is equal to or less than the predetermined threshold.

(3) Variance of Square Eigenvalue

When the variance of the square eigenvalues is larger than a predetermined threshold, it may be determined that the square eigenvalues are widely distributed.

(4) Average of square eigenvalues

When an average of the square eigenvalues is larger than a predetermined threshold, it may be determined that the square eigenvalues are widely distributed.

Although an example of the determination criterion for determining the distribution of the square eigenvalues has been described above, other criteria for determining whether the square eigenvalues are widely distributed are also conceivable.

In the diagnostic method according to the present embodiment, after determining whether a gradient vanishment occurs for a certain layer, it is determined whether gradient vanishment has been determined for all layers of the neural network model (S13), and if the determination has not been made for all layers (NO in S13), the gradient vanishment is determined based on the distribution of the square eigenvalues (S12).

When the gradient vanishment has been determined for all the layers (YES in S13), the determination result is output (S14). When there is no gradient vanishment for all layers, it is determined that the neural network does not lose the gradient, and when even one layer loses the gradient, it is determined that the neural network loses the gradient, and the determination result is output (S14). When outputting the determination result, the distribution state of the square eigenvalue may be displayed in a graph.

(Learning Device)

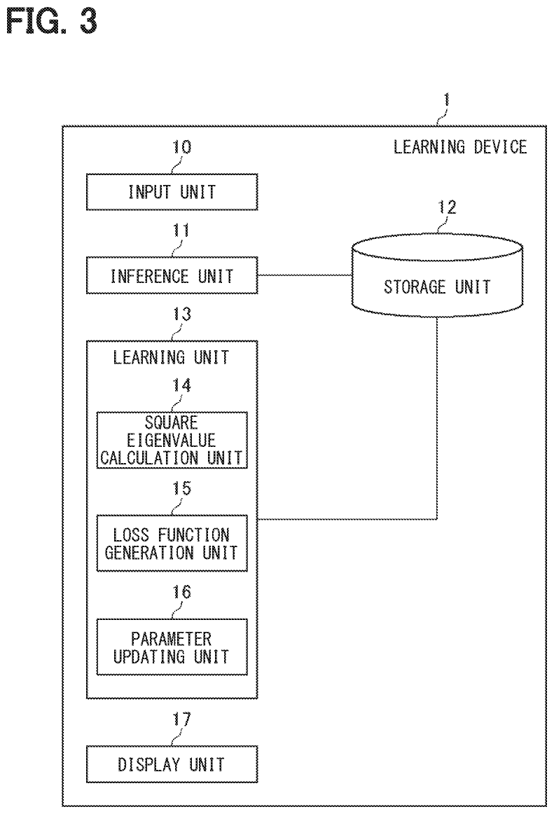

FIG. 3 is a diagram showing a configuration of the learning device 1 according to the present embodiment. The learning device 1 includes an input unit 10 for inputting teacher data (data and a correct answer label), an inference unit 11 for performing inference by use of the teacher data, a learning unit 13 for performing learning by back propagating an error between the inference result and the correct answer label, a storage unit 12 for storing a neural network model that is a learning target, and a display unit 17 for displaying a state of learning or the like. The learning unit 13 includes a square eigenvalue calculation unit 14, a loss function generation unit 15, and a parameter updating unit 16. The square eigenvalue calculation unit 14 has a function of calculating an input-output conversion expression (mathematical expression (1)) representing an output F with respect to an input X in each layer of the neural network to be learned. The loss function generation unit 15 has a function of generating a loss function used for error back propagation of the neural network. In the present embodiment, the loss function includes a penalty for controlling the square eigenvalue. The parameter updating unit 16 has a function of updating the parameters of the neural network by an error back propagation method so as to minimize a loss function generated by the loss function generation unit 15.

(Loss Function)

In the present embodiment, the loss function is a function for preventing the square eigenvalues from becoming too small. If all eigenvalues are greater than 0 (Positive Definite), then all column vectors of the matrix are linearly independent of each other. A loss function is used to ensure linear independence of the matrix so that the eigenvalues are not too small.

As a method of normalization, a determinant of the matrix (denoted as “Σ_{K, W}_{²}”) obtained by inputting the parameter matrix W to the input X and squaring the parameter matrix W is maximized. In the present embodiment, the minimization of a logarithmic determinant is performed as an operation equivalent to the maximization of the matrix expression of the matrix Σ_{K, W}_{²}.

max det(Σ_{K, W}²)↔min log det(Σ_{K, W}⁻²) [Mathematical expression (5)]

Assuming that the eigenvalues λi of the matrix Σ_{k, w}² are obtained, the following mathematical expression is satisfied.

Σ_{K, W}²=QΛQ^{T}, QQ^{T}=I, Λ_{i,i}λᵢ [Mathematical expression (6)]

Since the value of the matrix expression is equal to a product of the eigenvalues, a logarithmic inverse determinant is expressed by the sum of the logarithmic eigenvalues as in the following mathematical expression (7).

$$[ Mathematical expression ( 7 ) ]$$

$$log det ( {\sum }_{K , W}^{- 2} ) log {\prod }_{i} \frac{1}{{λ}_{i}} = - {\sum }_{i} log {λ}_{i} = - tr ( log Λ ) + φ ( Λ )$$

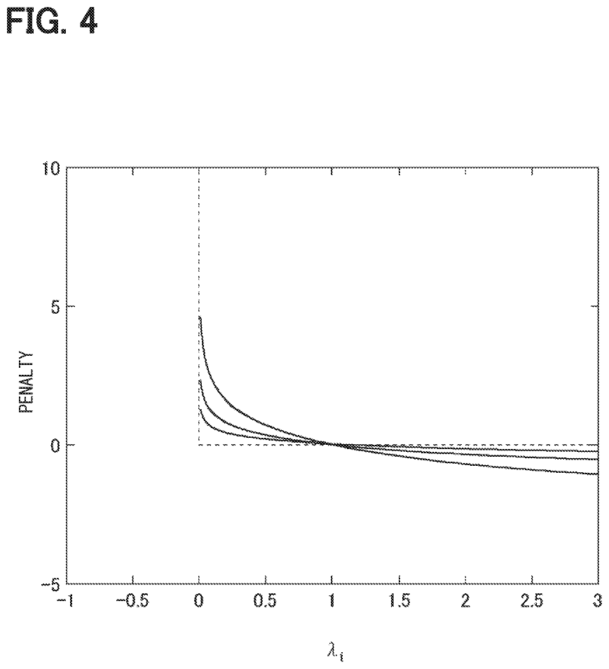

In this example, the property of φ(Λ)=−Σ log λi in the mathematical expression (7) will be described. In −log λi, as λi approaches 0, a function φ(Λ) approaches +∞ (logarithmic barrier). By use of the above property, as shown in FIG. 4, when the eigenvalue λi approaches 0, a penalty of +∞ is generated, and a loss function for preventing the eigenvalue λi from being 0 (that is, for promoting a non-linear independence) is generated during the learning. Next, in order to include the loss function in the update expression of a gradient descent method used in the error back propagation method, the gradient of φ(A) with respect to the parameter matrix W is specifically calculated. The gradient is obtained by calculating a differential of a synthesis function by use of a chain rule of the following mathematical expression (8).

$$[ Mathematical expression ( 8 ) ]$$

$$\frac{\partial φ ( Λ )}{\partial W} = \frac{\partial φ ( Λ )}{\partial Λ} \frac{\partial Λ}{\partial {\sum }^{2}} \frac{\partial {\sum }^{2}}{\partial \sum } \frac{\partial \sum }{\partial {WW}^{T}} \frac{\partial {W}^{T} W}{\partial W}$$

Each of terms 1 to 5 on a right side can be calculated by the following mathematical expression. The tr( ) in the first expression below is trace of the matrix and is the sum of main diagonal components of the matrix. The “∘” of the mathematical expression (9) is Hadamard product.

$$[ Mathematical expression ( 9 ) ]$$

$$φ ( {D}_{+} ) = - tr ( log {D}_{+} ) \to \frac{\partial φ ( {D}_{+} )}{\partial {D}_{+}} = - {D}_{+}^{- 1}$$

$$Λ = {Q}^{T} {\sum }^{2} Q \to Δ \frac{\partial Λ}{\partial {\sum }^{2}} = Q Λ {Q}^{T}$$

$$Δ \frac{\partial {\sum }^{2}}{\partial \sum } = Δ \sum + \sum Δ = {Sy}_{+} ( Δ \sum )$$

$$\sum = K ( {W}^{T} W ) \to Δ \frac{\partial \sum }{\partial {WW}^{T}} = Δ ∘ {\sum }^{′} \\ Δ \frac{\partial {W}^{T} W}{\partial W} = 2 Δ W$$

In the above mathematical expression, the following abbreviations are used.

$$[ Mathematical expression ( 10 ) ]$$

$$\sum = {\sum }_{K \cdot W} , {\sum }^{′} = \frac{\partial K ( {W}^{T} W )}{\partial {W}^{T} W}$$

$$Δ = \frac{\partial f ( F )}{\partial F} , {Sy}_{+} ( A ) = A + {A}^{T}$$

From the above description, the gradient indicated in the above mathematical expression (8) is obtained as follows.

$$[ Mathematical expression ( 11 ) ]$$

$$\frac{\partial φ ( Λ )}{\partial W} = - 2 ( {Sy}_{+} ( Q {Λ}^{- 1} {Q}^{T} \sum ) ∘ {\sum }^{′} ) W$$

An inverse of the above gradient (minus multiple) is added to the update expression of W and used as a loss function when the parameter is updated. As a result, the parameter matrix W can be moved in the opposite direction of the gradient.

Incidentally, the update expression including the loss function obtained in the mathematical expression (11) has a large calculation amount. Therefore, as a modification, low-rank approximation may be performed focusing only on small eigenvalues,

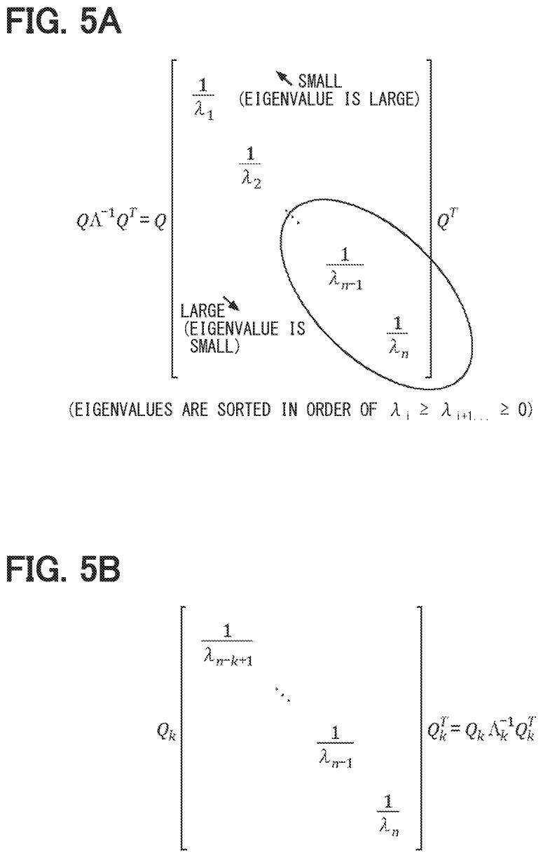

FIGS. 5A and 5B are diagrams illustrating the low-rank approximation. FIG. 5A is a diagonal matrix in which eigenvalues are sorted in descending order from the upper left to the lower right. In FIG. 5, since each component of the matrix is the inverse of the eigenvalue, the eigenvalue on the upper left side is smaller and the eigenvalue on the lower right side is larger. In the low-rank approximation, in FIG. 5A, a predetermined number of diagonal components (circled portions) are extracted from the smaller one, a small matrix as shown in FIG. 5B is formed, and the gradient to be added to the loss function is calculated by use of this matrix.

$$[ Mathematical expression ( 12 ) ]$$

$$\frac{\partial φ ( Λ )}{\partial W} = - 2 ( {Sy}_{+} ( {Q }_{k} {Λ}_{k}^{- 1} {Q}_{k}^{T} \sum ) ∘ {\sum }^{′} ) W$$

To further reduce the amount of calculation, only the smallest eigenvalue may be used to generate the following loss function:

$$[ Mathematical expression ( 13 ) ]$$

$$\frac{\partial φ ( {λ}_{min} )}{\partial W} = - \frac{2}{{λ}_{min}} ( {Sy}_{+} ( {v}_{min} {v}_{min}^{T} \sum ) ∘ {\sum }^{′} ) W$$

In the mathematical expression (13), λₘᵢₙ is the smallest eigenvalue and vₘᵢₙ is the eigenvector corresponding to the smallest eigenvalue.

Although the configuration of the learning device 1 according to the present embodiment has been described above, an example of hardware of the learning device 1 described above is a computer including a CPU, a RAM, a ROM, a hard disk, a display, a keyboard, a mouse, a communication interface, or the like. The learning device 1 is implemented by storing a program having modules for realizing the functions described above in a RAM or a ROM and executing the program by a CPU. The program described above also fall within the scope of the present disclosure.

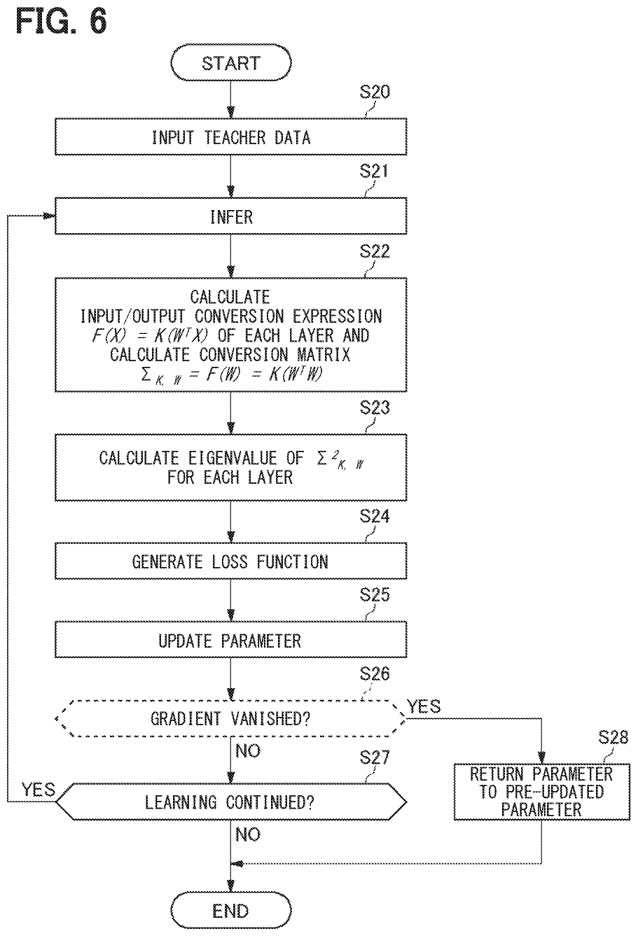

FIG. 6 is a flowchart showing the learning operation by the learning device 1. The learning device 1 receives input of teacher data (S20). The teacher data is configured by, for example, a set of data such as images and sounds, correct answer labels indicating what the above data is. The learning device 1 inputs the teacher data to the neural network to be learned, and performs inference (S21). The learning device 1 performs learning by back propagating the error between the inference result and the correct answer label, and the learning device 1 generates a loss function used for learning.

The learning device 1 obtains a conversion expression (the above mathematical expression (1)) of input and output in each layer of the neural network model being learned, and obtains a conversion matrix (the above mathematical expression (2)) from the conversion expression (S22). Next, the eigenvalue of the matrix obtained by inputting the parameter matrix VV to the input X of the conversion expression, and squaring the resulting matrix is obtained as the square eigenvalue (S23), and a loss function to which a penalty such that the square eigenvalue does not become 0 is added is generated (S24). The calculation of such a penalty is described above.

Next, the learning device 1 updates the parameter of the neural network by the error back propagation method by use of the generated loss function (S25). Next, the learning device 1 determines whether the gradient vanishment occurs in each layer of the neural network whose parameters have been updated, by use of the diagnostic method of the present embodiment described above (S26). In the above flowchart, the reason why the determination of the gradient vanishment is drawn by a dotted line is that the determination of the gradient vanishment does not need to be performed every time the parameter is updated, but may be performed, for example, when the learning of one to several epochs is completed.

As a result of the determination, if the gradient vanishment occurs (YES in S26), the learning device 1 ends the learning process, At this time, the parameters before the update may be stored, and after the learning is aborted, the parameters immediately before the gradient vanishment starts to occur may be returned (S28), S28 of returning to the immediately preceding parameter is optional.

When the gradient vanishment does not occur (NO in S26), it is determined whether the learning is continued (S27). Whether to continue the learning can be determined according to whether the update of the parameter has converged. If the learning is to be continued (YES in S25), the process returns to the inference process and the above-described process is repeated. If the learning is not to be continued (NO in S25), the learning process is terminated. The learning device 1 may calculate the square eigenvalue in each layer of the neural network and display the distribution of the square eigenvalues in a timely manner or in response to a request from a user.

Since the learning device 1 according to the present embodiment performs learning by use of a loss function including the penalty for preventing the square eigenvalue of each layer of the neural network from becoming 0, the independence of the linear conversion in each layer can be ensured and the occurrence of gradient vanishment can be reduced.

The learning device 1 according to the present embodiment determines whether the gradient vanishment occurs based on the distribution of the square eigenvalues of each layer, and when the gradient vanishment occurs, the learning is terminated, so that the learning can be terminated as soon as the gradient vanishment begins to occur.

In the present embodiment, the method for diagnosing the gradient vanishment and the learning device 1 for reducing the occurrence of the gradient vanishment have been described. Alternatively, the gradient explosion can be diagnosed or learning with reduced gradient explosion can be implemented by finding the square eigenvalues of each layer of the neural network.

If the square eigenvalue is too large, a gradient explosion is likely to occur. Whether the gradient explosion is likely to occur can be determined based on whether the square eigenvalue is equal to or more than a predetermined threshold. In addition, with the inclusion of a penalty for preventing the square eigenvalue from becoming too large in the loss function, learning with reduced occurrence of gradient explosion can be performed. Further, the loss function can be generated by performing the low-rank approximation in the same manner as in the embodiments described above, and when the occurrence of the gradient explosion is reduced, a predetermined number (including one) of square eigenvalues in descending order from the square eigenvalues are used for the calculation of the penalty.

In the diagnosis, when the square eigenvalues are widely distributed from a large value to a small value, the parameters of the corresponding layer are not degenerate, and gradient explosion is unlikely to occur. Conversely, if the value of the square eigenvalue is too large and the parameter is diverging, a gradient explosion is likely to occur.

In the embodiments described above, an all-coupled neural network has been described as an example, but the present disclosure can also be applied to a convolution neural network. A convolutional neural network can be considered as a matrix product of multiple pieces of data cropped in a sliding window and multiple filters, Therefore, in the convolutional neural network as in the case of the all-coupled neural network described above, the conversion in each layer can be expressed in the form of the conversion expression of the mathematical expression (1) described above.

The present disclosure is useful, for example, as a technique for learning the neural network.

The methods described in the present disclosure may be implemented by a special purpose computer created by configuring a memory and a processor programmed to execute one or more particular functions embodied in computer programs. Alternatively, the methods described in the present disclosure may be implemented by a special purpose computer created by configuring a processor provided by one or more special purpose hardware logic circuits. Alternatively, the methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable storage medium.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure,

1. A learning device for learning a neural network model, the learning device comprising:
a square eigenvalue calculation unit configured to
calculate a mathematical expression that
represents an output with respect to an input in each layer of a neural network and
is expressed by F(X)=K(W^{T}X) when the output is defined as F and corresponds to numeric character data, the input is defined as X and corresponds to image data or the numeric character data, nonlinear conversion is defined as K, and a parameter matrix is defined as W, in learning of the neural network;
calculate, as a plurality of square eigenvalues, a plurality of eigenvalues of a matrix obtained by inputting the parameter matrix to the input of the mathematical expression and squaring the matrix;
a loss function generation unit configured to generate a loss function including a penalty for controlling the plurality of square eigenvalues;
an input unit configured to receive an input of image data including a numeric character;
an inference unit configured to calculate the numeric character data based on the image data; and
a parameter updating unit configured to perform learning to minimize the loss function based on an error between the numeric character data and correct answer numeric character data prepared in advance, in order to match the numeric character data with the correct answer numeric character data.

2. A diagnostic method comprising:
calculating a mathematical expression that
represents an output with respect to an input in each layer of a neural network and
is expressed by F(X)=K(W^{T}X) when the output is defined as F, the input is defined as X, nonlinear conversion is defined as K, and a parameter matrix is defined as W, in learning of the neural network;
calculating, as a plurality of square eigenvalues, a plurality of eigenvalues of a matrix obtained by inputting the parameter matrix to the input of the mathematical expression and squaring the matrix; and
determining a gradient vanishment or a gradient explosion based on a distribution of the plurality of square eigenvalues.

3. The diagnostic method according to claim 2, wherein
determining the gradient vanishment or the gradient explosion includes:
determining the gradient vanishment or the gradient explosion based on at least one of
a ratio of the plurality of square eigenvalues,
absolute values of the plurality of square eigenvalues,
a variance of the plurality of square eigenvalues, or
an average of the plurality of square eigenvalues.

4. A learning method that learns a neural network model, the learning method comprising repeatedly:
calculating a mathematical expression that
represents an output with respect to an input in each layer of a neural network and
is expressed by F(X)=K(W^{T}X) when the output is defined as F, the input is defined as X, nonlinear conversion is defined as K, and a parameter matrix is defined as W;
calculating, as a plurality of square eigenvalues, a plurality of eigenvalues of a matrix obtained by inputting the parameter matrix to the input of the mathematical expression and squaring the matrix; and
learning the neural network model by utilizing a loss function including a penalty for controlling the plurality of square eigenvalues.

5. The learning method according to claim 4, wherein
when a gradient vanishment is prevented, the learning the neural network model includes utilizing a predetermined number of the plurality of square eigenvalues in ascending order of the plurality of square eigenvalues for calculating the penalty.

6. The learning method according to claim 4, wherein
when a gradient explosion is prevented, the learning the neural network model includes utilizing a predetermined number of the plurality of square eigenvalues in descending order of the plurality of square eigenvalues for calculating the penalty.

7. A learning device for learning a neural network model, the learning device comprising:
a square eigenvalue calculation unit configured to
calculate a mathematical expression that
represents an output with respect to an input in each layer of a neural network and
is expressed by F(X)=K(W^{T}X) when the output is defined as F, the input is defined as X, nonlinear conversion is defined as K, and a parameter matrix is defined as W, in learning of the neural network
calculate, as a plurality of square eigenvalues, a plurality of eigenvalues of a matrix obtained by inputting the parameter matrix to the input of the mathematical expression and squaring the matrix;
a loss function generation unit configured to generate a loss function including a penalty for controlling the plurality of square eigenvalues;
an input unit configured to receive an input of teacher data;
an inference unit configured to perform inference based on the teacher data; and
a parameter updating unit configured to perform learning to minimize the loss function based on an error between a result of the inference and correct answer data.

8. A tangible non-transitory computer-readable storage medium storing a program for performing learning of a neural network model, which causes a computer to:
calculate a mathematical expression that
represents an output with respect to an input in each layer of a neural network and
is expressed by F(X)=K(W^{T}X) when the output is defined as F, the input is defined as X, nonlinear conversion is defined as K, and a parameter matrix is defined as W, in learning of the neural network;
calculate, as a plurality of square eigenvalues, a plurality of eigenvalues of a matrix obtained by inputting the parameter matrix to the input of the mathematical expression and squaring the matrix; and
learn the neural network model by utilizing a loss function including a penalty for controlling the plurality of square eigenvalue.
